(19) United States
(12) Patent Application Publication
(10) Pub. No.: US 2022/0210661 A1
(43) Pub. Date: Jun. 30, 2022

(54) Determining Allocation of Resources in a Wireless Network

(71) Applicant: Telefonaktiebolaget LM Ericsson (publ), Stockholm (SE)

(72) Inventors: Christopher Richards, Ottawa (CA); Stephen Rayment, Ottawa (CA); Martin Sjödin, Göteborg (SE)

(21) Appl. No.: 17/138,318

(22) Filed: Dec. 30, 2020

(51) Int. Cl. H04W 16/14; H04W 72/04; H04W 72/08

(52) U.S. Cl. CPC H04W 16/14; H04W 72/082; H04W 72/0453

(57) ABSTRACT

Methods and apparatus are provided. In an example aspect, a method in a wireless communication device is provided. The method comprises receiving, from a network node, an indication of useable frequencies for unlicensed wireless communication by the wireless communication device, selecting one or more of the useable frequencies for unlicensed wireless communication, and sending an indication of the selected one or more of the useable frequencies to the network node.

### TECHNICAL FIELD

Examples of the present disclosure relate to methods and apparatus, for example a method in a wireless communication device for selecting a frequency for unlicensed wireless communication, and a method in a network node for receiving an indication of a selected frequency for unlicensed wireless communication by a wireless communication device.

### BACKGROUND

In certain countries, such as the USA and Canada, the 6 GHz frequency range is being opened up for unlicensed use. That is, for example, a wireless communication device will be able to communicate using frequencies within the 6 GHz band without needing a license to do so, provided that the device meets regulatory requirements. There may be existing “incumbent” operations in this frequency band (typically fixed microwave links), and draft regulations for the 6 GHz frequency band require that these operations are protected from harmful interference caused by unlicensed operations.

Regulatory bodies, such as the Federal Communications Commission (FCC) in the USA and Innovation, Science and Economic Development (ISED) in Canada, may provide regulations that require that spectrum assignments for full power (“standard power”) unlicensed operations are controlled by an Automatic Frequency Controller (AFC). Unlicensed base stations, e.g. 802.11 access points or 3GPP gNodeBs (gNBs) may be required by these regulations to provide location and other transmitter information to the AFC in order for the AFC to determine what frequency ranges can be used by the base station at that location, and at what transmitter power levels, so that incumbent services and devices are not impacted. The base station must then operate within the permitted frequencies and limits provided by the AFC.

### SUMMARY

Regulatory bodies are only defining high level requirements for signaling procedures between the base station and AFC, and not the specific signaling protocol(s) and procedures. The details are left to industry and industry forums. The AFC signaling procedures currently being defined by the Wi-Fi Alliance (WFA) do not provide for a base station to inform the AFC of the actual frequencies and transmit powers used by the base station out of the possible frequency range(s) and power limits provided by the AFC. This may have implications on incumbent service providers and incumbent devices, the AFC service providers or the regulators identifying any interference issues.

One aspect of the present disclosure provides a method in a wireless communication device. The method comprises receiving, from a network node, an indication of useable frequencies for unlicensed wireless communication by the wireless communication device, selecting one or more of the useable frequencies for unlicensed wireless communication, and sending an indication of the selected one or more of the useable frequencies to the network node.

Another aspect of the present disclosure provides a method in a network node. The method comprises sending, to a wireless communication device, an indication of useable frequencies for unlicensed wireless communication by the wireless communication device, and receiving, from the wireless communication device, an indication of a selected one or more of the useable frequencies selected by the wireless communication device for unlicensed wireless communication.

A further aspect of the present disclosure provides an apparatus in a wireless communication device. The apparatus comprises a processor and a memory. The memory contains instructions executable by the processor such that the apparatus is operable to receive, from a network node, an indication of useable frequencies for unlicensed wireless communication by the wireless communication device, select one or more of the useable frequencies for unlicensed wireless communication, and send an indication of the selected one or more of the useable frequencies to the network node.

A still further aspect of the present disclosure provides an apparatus in a network node. The apparatus comprises a processor and a memory. The memory contains instructions executable by the processor such that the apparatus is operable to send, to a wireless communication device, an indication of useable frequencies for unlicensed wireless communication by the wireless communication device, and receive, from the wireless communication device, an indication of a selected one or more of the useable frequencies selected by the wireless communication device for unlicensed wireless communication

An additional aspect of the present disclosure provides an apparatus in a wireless communication device. The apparatus is configured to receive, from a network node, an indication of useable frequencies for unlicensed wireless communication by the wireless communication device, select one or more of the useable frequencies for unlicensed wireless communication, and send an indication of the selected one or more of the useable frequencies to the network node.

A further aspect of the present disclosure provides an apparatus in a network node. The apparatus is configured to send, to a wireless communication device, an indication of useable frequencies for unlicensed wireless communication by the wireless communication device, and receive, from the wireless communication device, an indication of a selected one or more of the useable frequencies selected by the wireless communication device for unlicensed wireless communication.

Another aspect of the present disclosure provides a system comprising a wireless communication device (202) and a network node (204). The network node is configured to send (402), to the wireless communication device, an indication (212) of useable frequencies for unlicensed wireless communication by the wireless communication device. The wireless communication device is configured to receive (102), from the network node, the indication of useable frequencies for unlicensed wireless communication by the wireless communication device, select (104) one or more of the useable frequencies for unlicensed wireless communication, and send (106) an indication (216) of the selected one or more of the useable frequencies to the network node. The network node is configured to receive (404), from the wireless communication device, the indication of the selected one or more of the useable frequencies selected by the wireless communication device for unlicensed wireless communication.

Advantages provided by these and other embodiments may include one or more of the following. Embodiments may provide information regarding actual spectrum usage by unlicensed wireless communication devices at a network node such as an AFC. This data can in some examples be made available to and used by spectrum regulators, incumbent service providers or incumbent infrastructure vendor suppliers, unlicensed base station service providers or vendors, and/or AFC service providers. In some embodiments, information can be used to improve spectrum usage and/or reduce the impact of unlicensed wireless communication devices on incumbent devices or vice versa, and/or reduce the impact of unlicensed wireless communication devices on other unlicensed wireless communication devices.

### BRIEF DESCRIPTION OF THE FIGURES

For a better understanding of examples of the present disclosure, and to show more clearly how the examples may be carried into effect, reference will now be made, by way of example only, to the following Figures in which:

FIG. 1 is a flow chart of an example of a method in a wireless communication device;

FIG. 2 shows a particular example of communications within a network according to an example of this disclosure;

FIG. 3 shows another particular example of communications within a network according to an example of this disclosure;

FIG. 4 is a flow chart of an example of a method in a network node:

FIG. 5 is a schematic of an example of an apparatus in a wireless communication device;

FIG. 6 is a schematic of an example of an apparatus in a network node;

FIG. 7 schematically illustrates a telecommunication network connected via an intermediate network to a host computer;

FIG. 8 is a generalized block diagram of a host computer communicating via a base station with a user equipment over a partially wireless connection; and

FIGS. 9 to 12 are flowcharts illustrating methods implemented in a communication system including a host computer, a base station and a user equipment.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Embodiments of this disclosure may aim to protect certain communications and devices from interference, for example in an unlicensed band such as the 6 GHz band. In some examples, these communications and devices may include “incumbent” services and devices. These may include, for example, in the USA, allocations for Fixed Services, Mobile Services, and Fixed Satellite Services (FSS) across four sub-bands. Fixed microwave service licensees may include those operating point-to-point microwave links that support a variety of critical services provided by utilities, commercial and private entities and public safety agencies. The 6 GHz band is used to provide backhaul for commercial wireless providers (such as traffic between commercial wireless base stations and wireline networks), and links for coordination of railroad train movements, control of natural gas and oil pipelines, management of electric grids, and long-distance telephone service. The Broadcast Auxiliary Service and Cable Television Relay Service also operate in the 6 GHz band on both a fixed and mobile basis. Licensees in the 6 GHz hand may use broadcast auxiliary service and Cable Television Relay Service pick-up stations to transmit programming material from special events or remote locations, including electronic news gathering, back to the studio or other central receive locations. Television broadcast related microwave links, such as television studio transmitter links, television inter-city relay links and television translator relay links, operate primarily one-way point-to-point systems in the 6 GHz band. Additionally, Low Power Auxiliary Stations, which operate on an itinerant basis, are authorized to operate in the 6 GHz band on a secondary basis for uses such as portable cameras, wireless microphones, cues, and backstage communications. The Fixed Satellite Service (FSS) Earth-to-space may use the 6 GHz band. Predominant FSS uses of these frequencies include content distribution to television and radio broadcasters, including transportable antennas to cover live news and sports events, cable television and small master antenna systems, and backhaul of telephone and data traffic. Further details regarding the use of the 6 GHz band in the USA are provided in Federal Communications Commission FCC 20-51, In the Matter of Unlicensed Use of the 6 GHz Band, Expanding Flexible Use in Mid-Band Spectrum Between 3.7 and 24 GHz, Apr. 24, 2020. Other countries may also have incumbent services and devices in the 6 GHz band. Embodiments of this disclosure may relate to frequencies within the 6 GHz band and/or one or more other frequency ranges or hands.

Advantages provided by examples and embodiments of this disclosure may include one or more of the following. Embodiments may provide information regarding actual spectrum usage by unlicensed wireless communication devices at a network node such as an AFC. This data can in some examples be made available to and used by spectrum regulators, incumbent service providers or incumbent infrastructure vendor suppliers, unlicensed base station service providers or vendors, and/or AFC service providers. In some embodiments, information can be used to improve spectrum usage and/or reduce the impact of unlicensed wireless communication devices on incumbent devices or vice versa, and/or reduce the impact of unlicensed wireless communication devices on other unlicensed wireless communication devices.

FIG. 1 is a flow chart of an example of a method 100 in a wireless communication device. The wireless communication device may be a device that communicates in unlicensed spectrum or an unlicensed band, such as the 6 GHz band, although the device may additionally or alternatively communicate in other bands or frequency ranges. The wireless communication device may be for example an access point (AP) such as a Wi-Fi or 802.11 access point, a base station such as an eNodeB (eNB) or gNodeB, or another type of wireless communication device.

Step 102 of the method 100 comprises receiving, from a network node, an indication of useable frequencies for unlicensed wireless communication by the wireless communication device. For example, step 102 may comprise receiving one or more messages from the network node, and the one or more messages contain information as to the frequencies (e.g. frequency bands, channels, ranges and/or bandwidths) that the wireless communication device is permitted to use. The network node may be for example an Automatic Frequency Controller (AFC), a network controller node, or any other network node that may indicate to the wireless communication device the frequencies that it is permitted to use.

The useable frequencies may in some examples be all or a subset of available frequencies. For example, the available frequencies may be all frequencies within a particular band (e.g. the 6 GHz band) or allowed by a particular wireless communications technology (e.g. Wi-Fi, 4G, 5G etc.), all channels within a particular band or allowed by the technology, or all center frequencies (plus specified or implied bandwidths) within a particular band or allowed by the technology. In some examples, the useable frequencies may be based on the device's location. For example, the useable frequencies may omit frequencies where there is another other wireless communication device (or more than one) nearby the wireless communication device, e.g. within a certain distance of the wireless communication device, where in some examples that distance may depend on the transmit power used or useable by the wireless communication device and/or the other wireless communication device. The other wireless communication device(s) may include base stations, APs, incumbent devices such as microwave transmitters and/or any other type of wireless communication device. The network node (e.g. AFC) may in some examples select the useable frequencies for the wireless communication device from the available frequencies, based on knowledge of the location of the other wireless communication device(s) and the frequency or frequencies (and in some examples transmission power(s)) that each are using, as well as the location of the wireless communication device.

Step 104 of the method 100 comprises selecting one or more of the useable frequencies for unlicensed wireless communication. This may be performed in any suitable manner by the wireless communication device, such as for example randomly from the useable frequencies provided, selecting the first on the list of useable frequencies, selecting the least congested or least interfered useable frequency or frequencies (e.g. as measured by the wireless communication device), or in any other suitable manner. The wireless device may select one, some or all of the useable frequencies indicated in the indication, e.g. based on the number of useable frequencies and/or the requirements and capabilities of the wireless communication device.

In some examples, the indication of one or more useable frequencies may also include a rank for each frequency. Thus, the wireless communication device may select one or more of the useable frequencies based on the ranks. For example, the selected frequency or frequency may be the highest ranked frequency or frequencies. In some examples, the network node may determine the ranks, for example based on other wireless communication device(s) nearby the wireless communication device, and one or more of their locations, communication frequency or frequencies, transmission power(s) and so on.

In addition to or as an alternative to the rank, the indication may in some examples indicate a level of interference at the wireless communication device on each frequency. This may be determined in some examples by the network node, for example based on one or more interference reports from one or more other wireless communication devices nearby the wireless communication device, and/or calculation of the expected level of interference at the wireless communication device based on knowledge of the location (and in some examples frequency/frequencies and transmission power used) of one or more other wireless communication devices. Similarly, in some examples, in addition to or as an alternative to the rank or level of interference, the indication may indicate a utilization level on that frequency at or nearby the wireless device. For example, the utilization level may indicate a level of usage or traffic by one or more other wireless communication devices nearby the wireless communication device. The wireless communication device may in some examples use the interference level and/or level of utilization for each frequency to determine a frequency to use for unlicensed wireless communication. For example, the wireless communication device may select one or more frequencies with low or the lowest level of interference and/or utilization.

In some examples, the utilization level information may indicate data transferred by the wireless communication device and/or other devices in time periods, e.g. 1 hour periods, and/or may indicate peak usage hours, idle hours, and/or duty cycle of the wireless communication device (e.g. percentage of time transmitting/receiving over a reporting time period). The network node may in some examples collate information from multiple wireless communication devices (e.g. base stations and APs) to assess the impact of aggregate interference on incumbent devices, and can use that information to understand the impact of unlicensed wireless communication devices on incumbent devices.

The indication may in some examples additionally or alternatively provide a number of other wireless communication devices nearby the wireless communication device, and may specify this for each frequency (e.g. a number of nearby other wireless communication devices using each frequency). A higher number may indicate potentially higher interference for a particular frequency, for example. Thus, in some examples, the wireless communication device may use any one or more of, for each frequency the level of interference at the wireless communication device on that frequency, the rank, the utilization level of that frequency and the number of other wireless communication devices nearby the wireless communication device using that frequency, when selecting one or more frequencies in step 104 of the method 100.

Step 106 of the method 100 comprises sending an indication of the selected one or more of the useable frequencies to the network node. For example, the wireless communication device may send one or more messages to the network node informing the network node of the frequency or frequencies that the wireless communication device intends to use for unlicensed wireless communication.

In some examples, the wireless communication device measures a level of interference or a utilization level on each of the selected one or more of the useable frequencies, and sends an indication of the level of interference or the utilization level to the network node. This may also be performed by one or more other wireless communication devices, and also in some examples may be accompanied by the location of the measuring device. In this way, the network node may for example build up knowledge or a map of interference levels at various locations, which may also in some examples allow the network node to choose certain frequencies for including in the indication received by the wireless communication device, where those chosen frequencies may be those with lower interference levels at the device's location. In some examples, the indication of the level of interference may be sent by a wireless communication device to the network node when the level of interference exceeds a predetermined threshold, so that for example there are not a considerable number of interference measurements being reported in the network. In some examples, an indication of the predetermined threshold may be received from the network node, for example in the same message as the indication of useable frequencies.

The method 100 may include in some examples receiving an indication of a timer duration from the network node. This may be received for example in the same message as the indication of useable frequencies. On receipt of the indication of useable frequencies, the wireless communication device may start a timer. The indication of the selected one or more of the useable frequencies to the network node may be sent before or when the timer reaches the timer duration. For example, the timer duration may be a time period following receipt of the indication of the useable frequencies in which the wireless communication device is required to send the selected one or more frequencies to the network node.

In some examples, the method 100 comprises, after sending the indication of the selected one or more of the useable frequencies to the network node, selecting a further one or more of the useable frequencies for unlicensed wireless communication, and sending an indication of the selected further one or more of the useable frequencies to the network node. This may be done for example following receipt of an instruction from the network node, which may in some examples indicate a new list of frequencies that are useable by the wireless communication device, and may exclude the one or more frequencies selected in step 104. For example, the network node may determine from information it receives that the wireless communication device is causing interference with another device, such as an incumbent device, and may thus cause the wireless communication device to switch frequency. Additionally or alternatively, for example, selecting the further one or more of the useable frequencies and sending the indication of the selected further one or more of the useable frequencies to the network node are performed after a predetermined time after sending the indication of the selected one or more of the useable frequencies to the network node, and/or after determining that the further one or more of the useable frequencies has a lower interference level than the one or more of the useable frequencies. For example, after a predetermined time, such as 24 hours, the wireless communication device may be required to “refresh” the useable frequencies and select one or more frequencies once again. Additionally or alternatively, for example, if the wireless communication device determines from measurements that an unused frequency has a lower interference than the one or more selected frequencies, the device may select the further one or more of the useable frequencies and inform the network node accordingly. However, in some examples, where the wireless communication device wishes to switch to another frequency that was included in the indication of useable frequencies, the wireless communication device may not send another indication to the network node and hence may not inform the network node that the wireless communication device is using a different one (or more) of the useable frequencies.

The method 100 may in some examples comprise, after selecting the one or more of the useable frequencies, sending, to the network node, one or more indications of a utilization level of the selected one or more of the useable frequencies for unlicensed wireless communication by the wireless communication device. The network node may thus build up knowledge of the utilization level by the wireless communication device, and in some examples also by one or more other wireless communication devices, which may also be associated with the location of the device(s). In this way, the network node may tailor the indication of useable frequencies for wireless communication devices based on utilization level of frequencies nearby each device.

In some examples, the method 100 comprises sending, to the network node, a request for an indication of the useable frequencies for unlicensed wireless communication by the wireless communication device, and wherein the indication of the useable frequencies is received in response to the request. The request may in some examples identify requested frequencies, and the indication of the useable frequencies identifies the requested frequencies or a subset of the requested frequencies. The request may also identify the desired (maximum) transmission power for each of the frequencies. In any example, however, the indication of the useable frequencies from the network node may be accompanied by the maximum permitted transmission power for each of the useable frequencies.

Herein, the indication of the useable frequencies may in some examples comprise an indication of one or more useable frequency ranges, one or more useable channels, and/or one or more useable center frequencies. A frequency range may include for example a lower and an upper frequency, or alternatively may be a center frequency and bandwidth. Selecting one or more of the useable frequencies may in some examples comprise selecting one or more of one or more frequency ranges, one or more channels and/or one or more center frequencies.

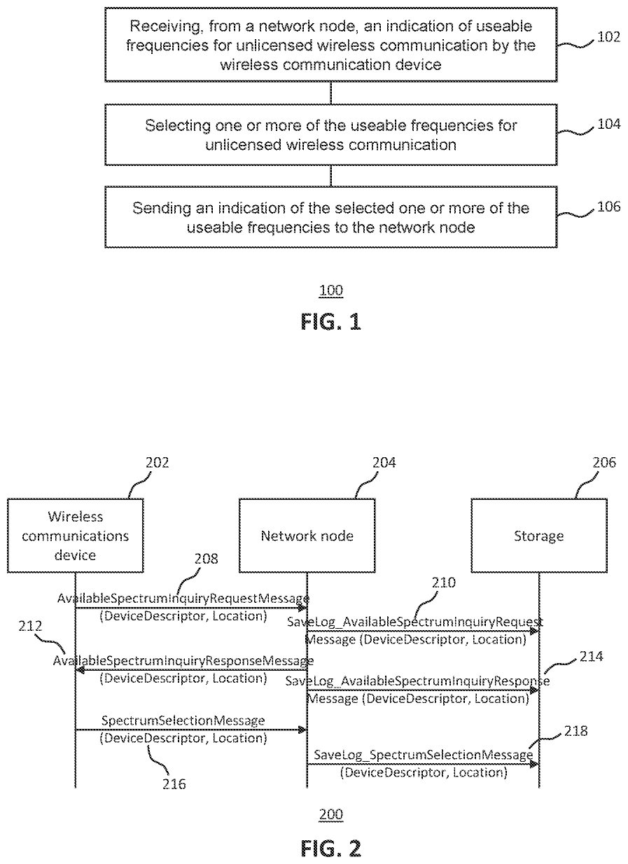

FIG. 2 shows a particular example of communications 200 within a network according to an example of this disclosure. The network includes a wireless communication device 202 (e.g. an access point or base station), a network node 204 (e.g. an AFC), and storage 206. The storage 206 may be used for example by the network node 204 to store information and/or messages, and may be local to or remote from the network node 204. In some examples, the storage 206 may store information and/or messages for multiple network nodes. In some examples, the network node may store all transactions (signaling messages) in a transaction log file in the storage as they are sent or received. Each stored transaction may include identifiers to match the transactions for each wireless communication device, e.g. a device descriptor.

In a first step, the wireless communication device 202 sends a message 208, referred to as AvailableSpectrumInquiryRequestMessage, to the network node 204. The message 208 specifies a DeviceDescriptor and a Location of the device 202. The DeviceDescriptor may for example uniquely identify the device 202, or alternatively may identify information about the device such as for example device type, capabilities, communication technologies etc. In response to receiving the message 208, the network node 204 may store the message or information relating to the message (such as the DeviceDescriptor and Location) in storage 206. This is done in the example shown in FIG. 2 by the network node 204 sending SaveLog_AvailableSpectrumInquiryRequestMessage 210 including DeviceDescriptor and Location to storage 206.

After receiving the message 208, the network node 204 sends

AvailableSpectrumInquiryResponseMessage 212 (in some examples with DeviceDescriptor and Location of the device 202) to the wireless communication device 202. The message 212 may for example identify the useable frequencies. The wireless communication device 202 may then select one or more of the useable frequencies for use for unlicensed wireless communication. The network node 204 also stores in the storage 206 the message 212 or information relating to the message 212 (e.g. DeviceDescriptor and Location of the device 202, and in some examples the useable frequencies), for example using SaveLog_AvailableSpectrumInquiryResponseMessage 214.

Once the wireless communication device 202 has chosen one or more frequencies, the device 202 sends a SpectrumSelectionMessage 216 with DeviceDescriptor and Location to the network node 204. The network node 204 stores the message 216 or information relating to the message 216 (e.g. DeviceDescriptor, Location, and selected one or more frequencies) in storage 206, for example using SaveLog_SpectrumSelectionMessage 218. In this way, for example, the location and frequencies used by the device 202 (and also in some examples the intended transmission power(s), indicated to the network node 204 in message 216 and stored via message 218) may be stored in storage 206, and may be used for various purposes. For example, information stored from multiple wireless communication devices may be used to identify potential interfering devices in a particular location where an incumbent device is experiencing interference, and/or the network node 204 may select or rank useable frequencies for wireless communication devices based on the stored information to attempt to improve performance of the wireless communication devices at their particular locations. The communications 200 shown in FIG. 2 may be sent in some examples according to examples of the method 100 described above and/or the method 300 described below.

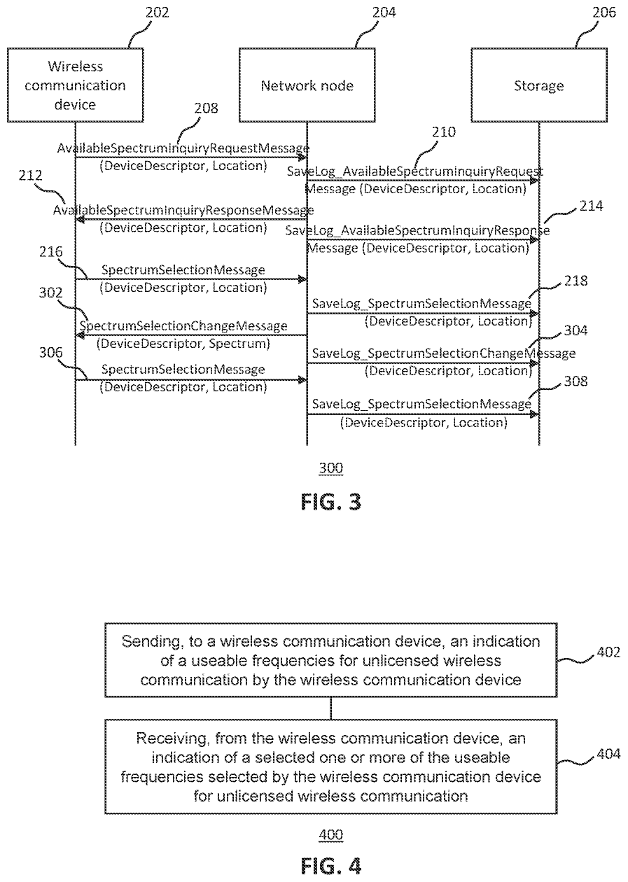

FIG. 3 shows another particular example of communications 300 within a network according to an example of this disclosure. The network includes a wireless communication device 202 (e.g. an access point or base station), a network node 204 (e.g. an AFC), and storage 206. The storage 206 may be used for example by the network node 204 to store information and/or messages, and may be local to or remote from the network node 204. In some examples, the storage 206 may store information and/or messages for multiple network nodes. In some examples, the network node may store all transactions (signaling messages) in a transaction log file in the storage as they are sent or received. Each stored transaction may include identifiers to match the transactions for each wireless communication device, e.g. a device descriptor. In some examples, the example shown in FIG. 3 may be an extension of that shown in FIG. 2. Therefore, nodes and communications in FIG. 3 that are similar to those in FIG. 2 are given the same reference numerals.

In the example of FIG. 3, steps and communications 208-218 may be performed as described above. However, following step 218, where the network node 204 stores the SpectrumSelectionMessage 216 or information relating to the message 216 in storage 206, the network node sends a SpectrumSelectionChangeMessage 302 to the wireless communication device 202 to instruct the wireless communication device 202 to change the spectrum that it is using (or that it is permitted to use). This may be done for example if the network node 204 determines that a particular frequency that is being used by the wireless communication device 202 or that the device 202 is permitted to use is no longer suitable for use by the device 202. For example, the network node 204 may receive a notification from another wireless communication device, such as an incumbent device, that the another wireless communication device is experiencing interference or other communication difficulties. The notification may also indicate the frequency concerned (or the network node may already know this or obtain this information by other means). In some examples, the SpectrumSelectionChangeMessage 302 may be sent to the wireless communication device 202 if the network node 204 determines that the device 202 is using or intends to use the frequency or frequencies concerned, for example if such frequency or frequencies were indicated in the SpectrumSelectionMessage 216.

The SpectrumSelectionChangeMessage 302 may in some examples indicate a DeviceDescriptor and Spectrum to the wireless communication device 202, where the Spectrum indicates the frequency or frequencies that the wireless communication device 202 should no longer use or is no longer permitted to use. Alternatively, the Spectrum may indicate a new set of frequencies that the device 202 is permitted to use. This may replace the useable frequencies indicated to the device 202 in the message 212. A SaveLog_SpectrumSelectionMessage 304 from the network node 204 to storage 206 stores the message 302 or information relating to the message 302.

The wireless communication device 202 may as a result of the SpectrumSelectionChangeMessage 302 change the frequency or frequency that it uses. In some examples, the device 202 may not change its frequencies, for example if it is not currently using a frequency that it is no longer permitted to use. In either case, the wireless communication device 202 sends a SpectrumSelectionMessage 306 to the network node 204 indicating the frequency or frequencies that it intends to use following the SpectrumSelectionChangeMessage 302. This information (and/or the entire message 306) may be stored in storage 206 via SaveLog_SpectrumSelectionMessage 308 sent from the network node 204 to storage 206.

FIG. 4 is a flow chart of an example of a method 400 in a network node. In some examples, the network node is an Automatic Frequency Controller (AFC). The method 400 comprises, in step 402, sending, to a wireless communication device, an indication of useable frequencies for unlicensed wireless communication by the wireless communication device. The wireless communication device may be for example a base station or AP. Step 404 of the method 400 comprises receiving, from the wireless communication device, an indication of a selected one or more of the useable frequencies selected by the wireless communication device for unlicensed wireless communication. In some examples, the wireless communication device may be performing the method 100 described above, and thus the variations and alternatives thereof as described herein may also be applied to the method 400 where appropriate.

In some examples, the method 400 comprises, before sending the indication of the useable frequencies to the wireless communication device, determining the useable frequencies from available frequencies. The useable frequencies may thus be a subset or all of the available frequencies. In some examples, the useable frequencies are determined based on one or more of, for each of the available frequencies, a level of interference at the wireless communication device on that frequency, a utilization level of that frequency at the wireless communication device, and a number of other wireless communication devices nearby the wireless communication device using that frequency. This information may be available to the network node for example in storage, such as storage 206 shown in FIG. 2 or 3.

In some additional enhancements of such examples, the method 400 may further comprise receiving, from each of at least one further wireless communication device, an indication of a selected one or more frequencies selected by the further wireless communication device for wireless communication and a location of the further wireless communication device. The network node may thus determine the number of other wireless communication devices nearby the wireless communication device based on the selected one or more frequencies selected by each of the one or more further wireless communication device and the location for each of the one or more further wireless communication device. In other words, for example, collecting information from multiple wireless communication devices would allow the network node to determine useable frequencies based on expected levels of interference at the wireless communication device's location based on any nearby other devices, and in some examples the frequencies and/or signal powers that the other devices are using. The other wireless communication devices may in some examples be unlicensed devices such as access points or base stations using unlicensed spectrum, and/or may include incumbent or licensed devices.

The method 400 may in some examples comprise receiving, from each of at least one further wireless communication device, a message comprising an indication of a selected one or more frequencies selected by the further wireless communication device for wireless communication and a location of the further wireless communication device. The network node may thus send, to the wireless communication device, an instruction to select an alternative one or more of the useable frequencies for wireless communication by the wireless communication device in response to the receiving. For example, the network node may send the instruction in order to reduce an interference level at the further wireless communication device(s) (each of which may be for example a base station. AP or incumbent device). In some examples, the message from each of the at least one further wireless communication device indicates that the further wireless communication device is experiencing interference on the selected one or more frequencies selected by the further wireless communication device. The network node may then determine that the wireless device is causing the interference, e.g. based on the device's location and/or the frequency or frequencies used by the device (and in some examples the transmission power). Sending the instruction to the wireless communication device to select the alternative one or more of the useable frequencies may be performed in response to determining that the wireless device is causing the interference.

The method 400 may in some examples comprise receiving, from a further wireless communication device (e.g. a base station, AP or incumbent device), a request for an indication of wireless communication devices nearby the further wireless communication device. For example, this information request may be performed if the further wireless communication device experiences interference. The network node may then send, to the further wireless communication device, the indication of one or more wireless communication devices nearby the further wireless communication device. The indication of one or more wireless communication devices nearby the further wireless communication device may in some examples include a location of the one or more wireless communication devices. Additionally or alternatively, the request may indicate one or more frequencies used by the further wireless communication device, and the indication of one or more wireless communication devices nearby the further wireless communication device may indicate one or more wireless communication devices nearby the further wireless communication device that use the frequencies used by the further wireless communication device. In this way, for example, interfering devices (and e.g. the frequencies used) may be identified.

The method 400 in some examples may comprise sending, to the wireless communication device, for each of the useable frequencies, an indication of one or more of a level of interference at the wireless communication device on that frequency, a rank of that frequency, a number of other wireless communication devices nearby the wireless communication device using that frequency, and a usage level of that frequency. The wireless communication device may therefore for example use this information to select one or more frequencies for use, for example selecting those frequency or frequencies that are expected to result in better performance by the wireless communication device (e.g. lower levels of interference or lower utilization level on the selected frequency or frequencies). The network node may in some examples determine the rank for each of the useable frequencies based on the level of interference at the wireless communication device on that frequency, the number of other wireless communication devices nearby the wireless communication device using that frequency and/or the usage level of that frequency. This information may for example be received from the wireless communication device and/or from one or more other wireless communication devices, including one or more base stations, APs and/or incumbent devices.

The network node may in some examples receive a request from an additional wireless communication device, such as a base station, AP or incumbent device. The network node may then send to the additional wireless communication device, in response to the request, an additional indication of one or more of a level of interference at the additional wireless communication device and a number of other wireless communication devices nearby the additional wireless communication device. The additional wireless communication device may thus for example be able to use the information, for example to select one or more frequencies to use for communication. The request and response may thus in some examples identify the frequency or frequencies that the additional wireless communication device intends to use. In particular instances of such examples, the request may indicate one or more frequencies, and the additional indication may comprise an indication of one or more of the level of interference at the additional wireless communication device on the one or more frequencies, and a number of other wireless communication devices nearby the additional wireless communication device that have selected at least one of the one or more frequencies for wireless communication. Thus, for example, the response may identify all available or useable frequencies, and may indicate a level of interference at the additional wireless communication device (based on its location) for each, and/or may identify a number of nearby devices using each frequency.

The method 400 may in some example comprise receiving, for each of the useable frequencies, from the wireless communication device and/or one or more further wireless communication device, an indication of the level of interference on that frequency and/or an indication of the usage level of that frequency by the wireless communication device and/or one or more further wireless communication device. Thus the network node may build up this information, and use it for example to select the useable frequencies for a device, determine the information accompanying the useable frequencies (e.g. interference, rank, utilization level etc.), and/or information sent to other devices. In some examples, the network node may send an indication of a predetermined threshold to the wireless communication device. Thus, receiving, for each of the useable frequencies, the indication of the level of interference on that frequency from the wireless communication device may comprise receiving the indication of the level of interference when the level of interference on that frequency at the wireless communication device exceeds the predetermined threshold. Using a predetermined threshold in this manner may for example ensure that a wireless communication device only reports interference levels on a particular frequency when that interference level is high, and not at other times (which may keep the level of traffic generated by the interference reports at a reasonable level, for example).

In some examples, the network node may send an indication of a timer duration to the wireless communication device. The network node may therefore expect a reply (e.g. the message 212 shown in FIG. 2 or 3) from the wireless communication device within the timer duration after sending the indication of useable frequencies. Thus for example the network node may receive the indication of the selected one or more of the useable frequencies from the wireless communication device comprises receiving the indication of the selected one or more of the useable frequencies before or when a timer reaches the timer duration. The timer may be implemented for example by the network node as well as the wireless communication device. If no response is received during the timer duration, the network node may determine may for example enter a ‘No response received’ indication in storage (e.g. storage 206). This may include a timestamp.

The method 400 may in some examples include receiving, from the wireless communication device, a request for an indication of useable frequencies for unlicensed wireless communication by the wireless communication device. In such examples, the indication of the useable frequencies may be sent in step 302 in response to the request. The request may for example identify one or more requested frequencies, and the indication of useable frequencies may identify the requested frequency or frequencies or a subset of the requested frequencies.

As noted above, the information gathered by the network node, for example the indication of selected one or more frequencies from one or more wireless communication devices (including base stations, APs and/or incumbent devices), may be used for various purposes. For example, this information may be used by an incumbent device to identify the nature (e.g. location, frequencies used, transmission powers used, device type etc) of an interfering device. This information may be used for example by the incumbent device to mitigate the impact of the interfering device. Additionally or alternatively, for example, incumbent devices can provide feedback to the network node to cause the network node to select the useable frequencies for wireless communication device(s) to mitigate the impact of activity by the wireless communication device(s) on incumbent device(s).

In addition or as an alternative, regulators or regulatory bodies may in some examples use the information to track or investigate reported interference issues from incumbent devices (or their operators or vendors). Spectrum regulators may for example be able to use the information to determine if an unlicensed wireless communication device is using frequency/frequencies that it is permitted to use and at the permitted transmitter power levels, to ensuring that equipment is complying with spectrum regulations. Regulators may for example use the information to determine spectrum usage, e.g. by location, frequency, by time, etc. In some examples, vendors and/or operators of wireless communication devices may use the information to improve their networks operation and performance, for example by avoiding co-channel interference.

FIG. 5 is a schematic of an example of an apparatus 500 in a wireless communication device. The apparatus 500 comprises processing circuitry 502 (e.g. one or more processors) and a memory 504 in communication with the processing circuitry 502. The memory 504 contains instructions executable by the processing circuitry 502. The apparatus 500 also comprises an interface 506 in communication with the processing circuitry 502. Although the interface 506, processing circuitry 502 and memory 504 are shown connected in series, these may alternatively be interconnected in any other way, for example via a bus.

In one embodiment, the memory 504 contains instructions executable by the processing circuitry 502 such that the apparatus 500 is operable to receive, from a network node, an indication of useable frequencies for unlicensed wireless communication by the wireless communication device, select one or more of the useable frequencies for unlicensed wireless communication, and send an indication of the selected one or more of the useable frequencies to the network node. In some examples, the apparatus 500 is operable to carry out the method 100 described above with reference to FIG. 1.

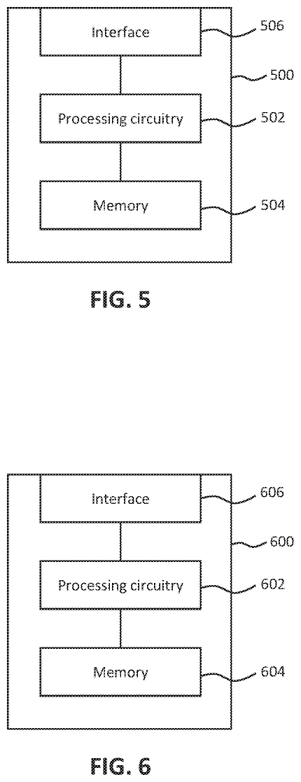

FIG. 6 is a schematic of an example of an apparatus 600 in a network node. The apparatus 600 comprises processing circuitry 602 (e.g. one or more processors) and a memory 604 in communication with the processing circuitry 602. The memory 604 contains instructions executable by the processing circuitry 602. The apparatus 600 also comprises an interface 606 in communication with the processing circuitry 602. Although the interface 606, processing circuitry 602 and memory 604 are shown connected in series, these may alternatively be interconnected in any other way, for example via a bus.

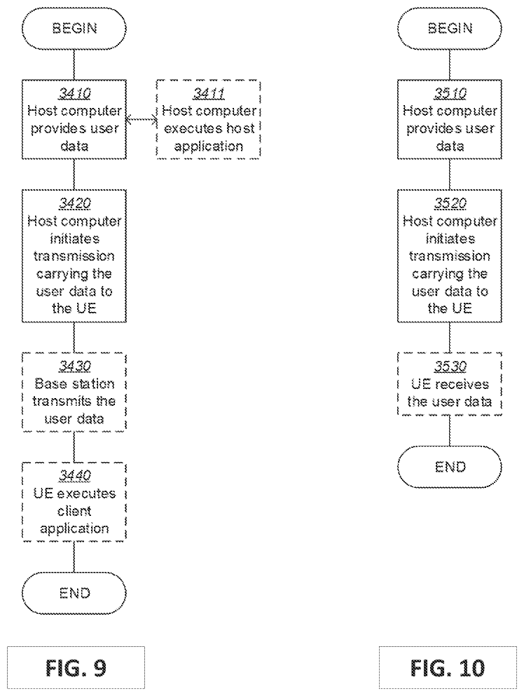

In one embodiment, the memory 604 contains instructions executable by the processing circuitry 602 such that the apparatus 600 is operable to send, to a wireless communication device, an indication of useable frequencies for unlicensed wireless communication by the wireless communication device, and receive, from the wireless communication device, an indication of a selected one or more of the useable frequencies selected by the wireless communication device for unlicensed wireless communication. In some examples, the apparatus 600 is operable to carry out the method 400 described above with reference to FIG. 9.

In another example, an apparatus in a wireless communication device is provided. The apparatus comprises a receiving module configured to receive, from a network node, an indication of useable frequencies for unlicensed wireless communication by the wireless communication device, a selection module configured to select one or more of the useable frequencies for unlicensed wireless communication, and a sending module configured to send an indication of the selected one or more of the useable frequencies to the network node.

In another example, an apparatus in a network node is provided. The network node comprises a sending module configured to send, to a wireless communication device, an indication of useable frequencies for unlicensed wireless communication by the wireless communication device, and a receiving module configured to receive, from the wireless communication device, an indication of a selected one or more of the useable frequencies selected by the wireless communication device for unlicensed wireless communication.

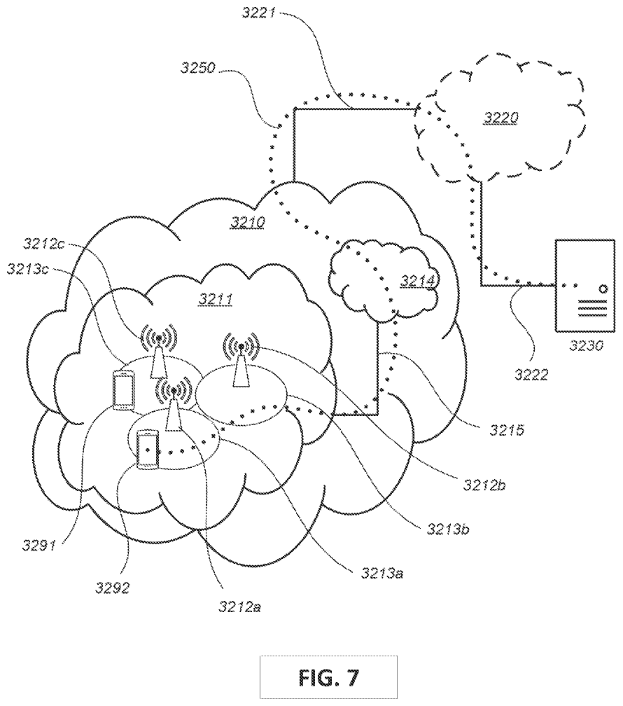

With reference to FIG. 7, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network: the intermediate network 3220, if any, may be a backbone network or the Internet; in particular, the intermediate network 3220 may comprise two or more sub-networks (not shown).

The communication system of FIG. 7 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

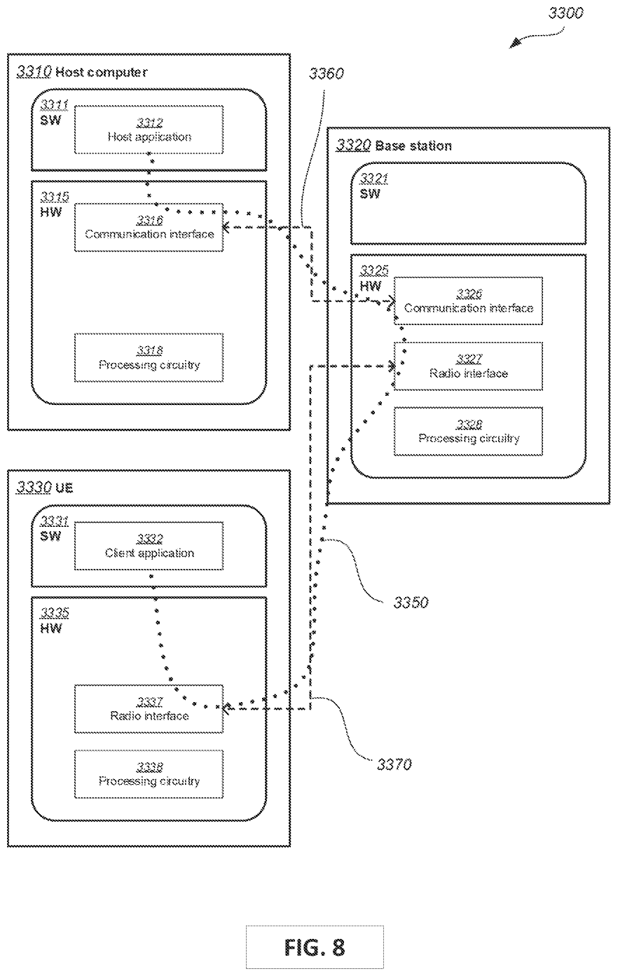

Example implementations, in accordance with an embodiment, of the UE, base station and host computer discussed in the preceding paragraphs will now be described with reference to FIG. 8. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 8) served by the base station 3320. The communication interface 3326 may be configured to facilitate a connection 3360 to the host computer 3310. The connection 3360 may be direct or it may pass through a core network (not shown in FIG. 8) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 8 may be identical to the host computer 3230, one of the base stations 3212a, 3212b, 3212c and one of the UEs 3291, 3292 of FIG. 7, respectively. This is to say, the inner workings of these entities may be as shown in FIG. 8 and independently, the surrounding network topology may be that of FIG. 7.

In FIG. 8, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the muting, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 may be in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve spectrum usage or interference experienced by devices and thereby provide benefits such as reduced interference, increased spectrum usage and efficiency, decreased latency, increased throughput etc.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

FIG. 9 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 9 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 10 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 10 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

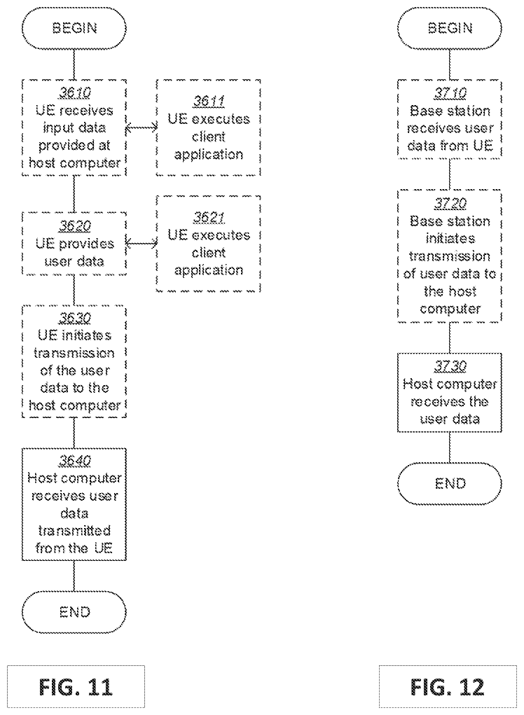

FIG. 11 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 11 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 12 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

The following numbered embodiments form part of this disclosure:

1. A base station configured to communicate with a user equipment (UE), the base station comprising a radio interface and processing circuitry configured to perform one or more of the methods disclosed herein, such as for example the method 100 described above.

2. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform one or more of the methods disclosed herein.

3. The communication system of embodiment 2, further including the base station.

4. The communication system of embodiment 3, further including the UE, wherein the UE is configured to communicate with the base station.

5. The communication system of embodiment 4, wherein:
the processing circuitry of the host computer is configured to execute a host application, thereby providing the user data; and
the UE comprises processing circuitry configured to execute a client application associated with the host application.

6. A method implemented in a base station, comprising one or more of the methods disclosed herein, such as for example the method 100 described above.

7. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs one or more of the methods disclosed herein, such as for example the method 100 described above.

8. The method of embodiment 7, further comprising:
at the base station, transmitting the user data.

9. The method of embodiment 8, wherein the user data is provided at the host computer by executing a host application, the method further comprising:
at the UE, executing a client application associated with the host application.

10. A base station configured to communicate with a user equipment (UE), the base station comprising a radio interface and processing circuitry configured to perform one or more of the methods as disclosed herein, such as for example the method 100 described above.

11. A communication system including a host computer comprising a communication interface configured to receive user data originating from a transmission from a user equipment (UE) to a base station, wherein the base station comprises a radio interface and processing circuitry, the base station's processing circuitry configured to perform one or more of the methods as disclosed herein, such as for example the method 100 described above.

12. The communication system of embodiment 11, further including the base station.

13. The communication system of embodiment 12, further including the UE, wherein the UE is configured to communicate with the base station.

14. The communication system of embodiment 13, wherein:
the processing circuitry of the host computer is configured to execute a host application;
the UE is configured to execute a client application associated with the host application, thereby providing the user data to be received by the host computer.

15. A method implemented in a base station, comprising one or more of the methods as disclosed herein, such as for example the method 100 described above.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e. the first or second of such features to occur in time or space) unless explicitly stated otherwise. Steps in the methods disclosed herein may be carried out in any order unless expressly otherwise stated. Any reference signs in the statements shall not be construed so as to limit their scope.

1-54. (canceled)

55. A method in a wireless communication device, the method comprising:
receiving, from a network node, an indication of useable frequencies for unlicensed wireless communication by the wireless communication device;
selecting one or more of the useable frequencies for unlicensed wireless communication; and
sending an indication of the selected one or more of the useable frequencies to the network node.

56. The method of claim 55, further comprising receiving, from the network node, for each of the useable frequencies, an indication of one or more of:
a level of interference at the wireless communication device on that frequency;
a rank;
a utilization level of that frequency; and
a number of other wireless communication devices nearby the wireless communication device using that frequency.

57. The method of claim 56, wherein selecting the one or more of the useable frequencies comprises selecting the one or more of the useable frequencies based on the level of interference, rank, channel load and/or number of other wireless communication devices for each of the useable frequencies.

58. The method of claim 55, wherein the method comprises measuring a level of interference or a utilization level on each of the selected one or more of the useable frequencies and sending an indication of the level of interference or the utilization level to the network node.

59. The method of claim 58, wherein sending an indication of the level of interference to the network node comprises sending the indication of the level of interference to the network node when the level of interference exceeds a predetermined threshold, the method further comprising receiving an indication of the predetermined threshold from the network node.

60. The method of claim 55, comprising:
receiving an indication of a timer duration from the network node; and
starting a timer on receipt of the indication of the useable frequencies;
and wherein sending the indication of the selected one or more of the useable frequencies to the network node comprises sending the indication of the selected one or more of the useable frequencies before or when the timer reaches the timer duration.

61. The method of claim 55, comprising, after sending the indication of the selected one or more of the useable frequencies to the network node, selecting a further one or more of the useable frequencies for unlicensed wireless communication, and sending an indication of the selected further one or more of the useable frequencies to the network node.

62. The method of claim 55, comprising, after selecting the one or more of the useable frequencies, sending, to the network node, one or more indications of a utilization level of the selected one or more of the useable frequencies for unlicensed wireless communication by the wireless communication device.

63. The method of claim 55, comprising sending, to the network node, a request for an indication of the useable frequencies for unlicensed wireless communication by the wireless communication device, and wherein the indication of the useable frequencies is received in response to the request.

64. The method of claim 55, comprising:
receiving, from the network node, an instruction to select an alternative one or more of the useable frequencies for wireless communication by the wireless communication device; and
selecting the alternative one or more of the useable frequencies for wireless communication by the wireless communication device.

65. The method of claim 55, wherein the indication of the useable frequencies comprises an indication of one or more of:
one or more useable frequency ranges;
one or more useable channels; and
one or more useable center frequencies.

66. The method of claim 55, wherein the network node comprises an Automatic Frequency Controller (AFC).

67. The method of claim 55, wherein the wireless communication device comprises an access point or a base station.

68. A method in a network node, the method comprising:
sending, to a wireless communication device, an indication of useable frequencies for unlicensed wireless communication by the wireless communication device; and
receiving, from the wireless communication device, an indication of a selected one or more of the useable frequencies selected by the wireless communication device for unlicensed wireless communication.

69. The method of claim 68, comprising, before sending the indication of the useable frequencies to the wireless communication device, determining the useable frequencies from available frequencies, wherein determining the useable frequencies from available frequencies is based on one or more of, for each of the available frequencies:
a level of interference at the wireless communication device on that frequency;
a utilization level of that frequency at the wireless communication device; and
a number of other wireless communication devices nearby the wireless communication device using that frequency.

70. The method of claim 68, further comprising:
receiving, from each of at least one further wireless communication device, an indication of a selected one or more frequencies selected by the further wireless communication device for wireless communication and a location of the further wireless communication device; and
determining the number of other wireless communication devices nearby the wireless communication device based on the selected one or more frequencies selected by each of the one or more further wireless communication device and the location for each of the one or more further wireless communication device.

71. The method of claim 68, comprising:
receiving, from each of at least one further wireless communication device, a message comprising an indication of a selected one or more frequencies selected by the further wireless communication device for wireless communication and a location of the further wireless communication device; and
sending, to the wireless communication device, an instruction to select an alternative one or more of the useable frequencies for wireless communication by the wireless communication device in response to the receiving.

72. The method of claim 71, wherein the message from each of the at least one further wireless communication device indicates that the further wireless communication device is experiencing interference on the selected one or more frequencies selected by the further wireless communication device, and the method comprises determining that the wireless communication device is causing the interference, and wherein sending the instruction to the wireless communication device to select the alternative one or more of the useable frequencies is performed in response to determining that the wireless device is causing the interference.

73. The method of claim 68, comprising:
receiving, from a further wireless communication device, a request for an indication of wireless communication devices nearby the further wireless communication device; and
sending, to the further wireless communication device, the indication of one or more wireless communication devices nearby the further wireless communication device,
wherein:
the indication of one or more wireless communication devices nearby the further wireless communication device includes a location of the one or more wireless communication devices; and/or
the request indicates one or more frequencies used by the further wireless communication device, and the indication of one or more wireless communication devices nearby the further wireless communication device indicates one or more wireless communication devices nearby the further wireless communication device that use the frequencies used by the further wireless communication device.

74. The method of claim 68, comprising sending, to the wireless communication device, for each of the useable frequencies, an indication of one or more of:
a level of interference at the wireless communication device on that frequency;
a rank of that frequency;
a number of other wireless communication devices nearby the wireless communication device using that frequency; and
a utilization level of that frequency.

75. The method of claim 68, comprising receiving a request from an additional wireless communication device, and sending to the additional wireless communication device in response to the request an additional indication of one or more of:
a level of interference at the additional wireless communication device; and
a number of other wireless communication devices nearby the additional wireless communication device.

76. The method of claim 68, comprising receiving, for each of the useable frequencies, from the wireless communication device and/or one or more further wireless communication device, an indication of the level of interference on that frequency and/or an indication of the utilization level of that frequency by the wireless communication device and/or one or more further wireless communication device.

77. The method of claim 68, comprising:
sending an indication of a timer duration to the wireless communication device;
and wherein receiving the indication of the selected one or more of the useable frequencies from the wireless communication device comprises receiving the indication of the selected one or more of the useable frequencies before or when a timer reaches the timer duration.

78. An apparatus in a wireless communication device, wherein the apparatus comprises a processor and a memory, the memory containing instructions executable by the processor such that the apparatus is configured to:
receive, from a network node, an indication of useable frequencies for unlicensed wireless communication by the wireless communication device;
select one or more of the useable frequencies for unlicensed wireless communication; and
send an indication of the selected one or more of the useable frequencies to the network node.

79. An apparatus in a network node, wherein the apparatus comprises a processor and a memory, the memory containing instructions executable by the processor such that the apparatus is configured to:
send, to a wireless communication device, an indication of useable frequencies for unlicensed wireless communication by the wireless communication device; and
receive, from the wireless communication device, an indication of a selected one or more of the useable frequencies selected by the wireless communication device for unlicensed wireless communication.

80. A system comprising a wireless communication device and a network node, wherein:
the network node is configured to send, to the wireless communication device, an indication of useable frequencies for unlicensed wireless communication by the wireless communication device;
the wireless communication device is configured to receive, from the network node, the indication of useable frequencies for unlicensed wireless communication by the wireless communication device, select one or more of the useable frequencies for unlicensed wireless communication, and send an indication of the selected one or more of the useable frequencies to the network node; and
the network node is configured to receive, from the wireless communication device, the indication of the selected one or more of the useable frequencies selected by the wireless communication device for unlicensed wireless communication.
